(19) United States
(12) Patent Application Publication
(10) Pub. No.: US 2026/0178371 A1
(43) Pub. Date: Jun. 25, 2026

(54) Micro-Containerized CPU Architecture for Efficient AI Workloads

(71) Applicant: M MOSTAGIR BHUIYAN, Arverne, NY (US)

(72) Inventor: M MOSTAGIR BHUIYAN, Arverne, NY (US)

(21) Appl. No.: 19/262,056

(22) Filed: Jul. 7, 2025

Related U.S. Application Data
(60) Provisional application No. 63/794,191, filed on Apr. 24, 2025.

(51) Int. Cl. G06F 9/48

(52) U.S. Cl. CPC G06F 9/48

(57) ABSTRACT

A system and method for enhancing the performance of a Central Processing Unit (CPU) for artificial intelligence (AI) workloads. An orchestration engine logically partitions physical CPU cores into a plurality of “micro-containers,” which are isolated execution sandboxes. A workload profiler analyzes incoming AI tasks and provides performance metrics to an autoscaler. The autoscaler dynamically adjusts the number of active micro-containers on each core to optimize performance based on real-time hardware counter data, such as instructions-per-cycle or cache-miss rates. This architecture allows general-purpose CPUs to achieve performance comparable to specialized GPUs for parallel processing tasks, while reducing cost and power consumption.

### CROSS-REFERENCE TO RELATED APPLICATIONS

This application claims the benefit of U.S. Provisional Application No. 63/794,191, filed on Apr. 24, 2025, which is hereby incorporated by reference in its entirety.

### BACKGROUND OF THE INVENTION

The present invention relates to the field of computer hardware and processing, and more specifically to a system and method for optimizing the performance of Central Processing Units (CPUs) for highly parallel workloads typical in artificial intelligence (AI) and machine learning (ML).

The background of the invention is the increasing reliance on expensive, power-intensive Graphics Processing Units (GPUs) for AI/ML tasks. While modern CPUs have significant computational resources, such as numerous physical cores and Simultaneous Multithreading (SMT) capabilities, they lack a fine-grained orchestration layer to effectively parallelize tasks at a sub-core level.

Prior art in this field includes hardware-guided scheduling technologies such as Intel's Thread Director. Such systems use hardware feedback to provide hints to a conventional operating system (OS) scheduler, which then places entire software threads onto different types of physical cores (e.g., performance-cores vs. efficiency-cores). However, these systems still rely on the OS to manage scheduling and do not create new, isolated execution units within a single core. The present invention is fundamentally different in that it actively partitions and manages sub-core resources to create new logical processing units, rather than merely advising on the placement of existing threads.

### BRIEF SUMMARY OF THE INVENTION

The invention introduces a system and method for enhancing the performance of a Central Processing Unit (CPU) for artificial intelligence (AI) workloads. The system features an orchestration engine that logically partitions physical CPU cores into a plurality of “micro-containers,” which are isolated execution sandboxes. A workload profiler analyzes incoming AI tasks and provides performance metrics, derived from real-time hardware counters, to an autoscaler. The autoscaler dynamically adjusts the number of active micro-containers on each core to optimize performance. This architecture allows general-purpose CPUs to achieve performance comparable to specialized GPUs for parallel processing tasks.

### BRIEF DESCRIPTION OF THE SEVERAL VIEWS OF THE DRAWING(S)

FIG. 1 is a system-level block diagram illustrating the overall architecture of the micro-containerized CPU system.

FIG. 2 is a block diagram detailing the components of an individual micro-container.

FIG. 3 is a flowchart illustrating the feedback loop between the workload profiler, hardware metrics, and the autoscaler.

### DETAILED DESCRIPTION OF THE INVENTION

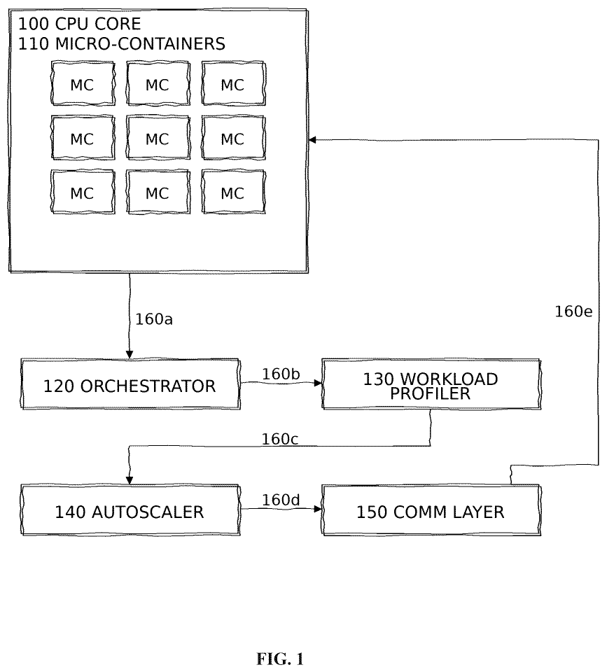

As shown in FIG. 1, the system is implemented on a processor package having one or more physical CPU cores 100. An Orchestrator Engine 120 logically partitions these cores 100 into a plurality of Micro-Containers (MCs) 110.

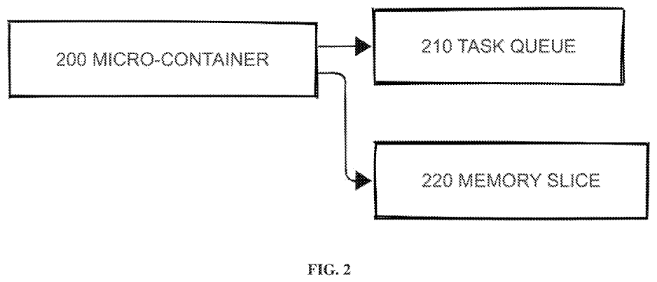

Each Micro-Container (MC) 200, detailed in FIG. 2, is an isolated execution sandbox within a single physical CPU core. It is allocated its own resources, including a dedicated Task Queue 210 and a protected Memory Slice 220, which may be a dedicated portion of the L2 cache.

Referring again to FIG. 1, the Orchestrator Engine 120 is a kernel-level or hypervisor service responsible for managing the lifecycle of the MCs, including instantiation, pausing, and termination. It works in concert with a Workload Profiler (WP) 130 and an Autoscaler (AS) 140.

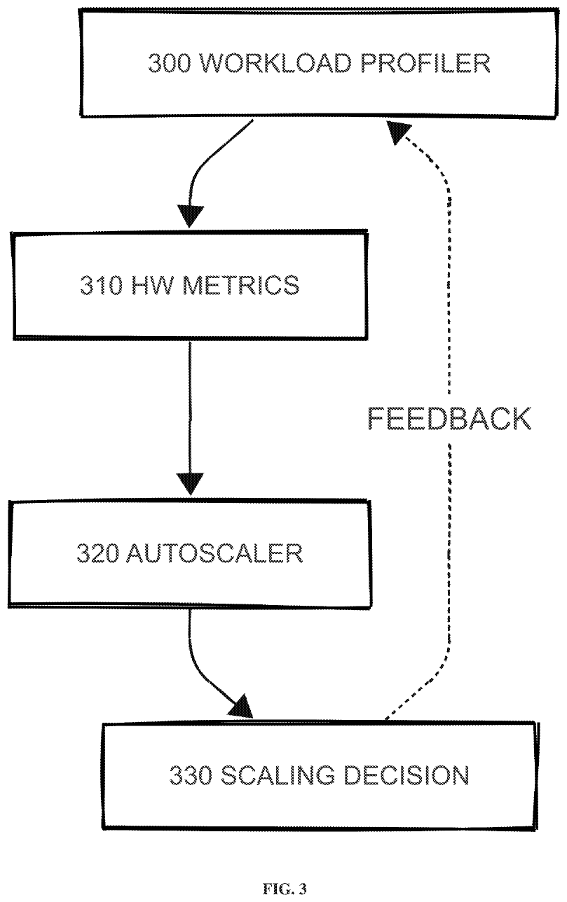

The Workload Profiler 130, as illustrated in the feedback loop of FIG. 3, monitors incoming AI workloads. It samples key Hardware Metrics 310, such as hardware performance counters, to classify the workload's characteristics, for instance, by measuring its General Matrix Multiply (GEMM) saturation or arithmetic intensity.

This data is fed to the Autoscaler 140. The Autoscaler 140 is a key inventive component that provides a hardware-aware feedback loop. In response to the profiler's data, it makes a Scaling Decision 330 to dynamically vary the number of active MCs 110 per core. For example, if the instructions-per-cycle (IPC) metric falls below a predetermined threshold, the autoscaler may increase the number of active MCs to improve parallelism. Conversely, it can power-gate idle MCs or migrate tasks in response to thermal throttling to manage power and heat.

A Communication Layer (CL) 150 is provided to enable efficient, low-latency data exchange between the MCs. This layer can be implemented using high-performance mechanisms such as lock-free ring buffers, enabling deterministic, GPU-like coordination between the parallel units.

What is claimed is:

1. A computer system for executing an artificial intelligence workload, the system comprising:
a processor comprising a plurality of physical cores;
an orchestration engine, stored in memory and executable by the processor, configured to logically partition at least one of the plurality of physical cores into a plurality of micro-containers by managing sub-core execution resources, wherein each micro-container of the plurality of micro-containers is an isolated execution sandbox having an associated task queue and dedicated resource bounds;
a workload profiler communicatively coupled to the orchestration engine, the workload profiler configured to monitor hardware performance metrics of the artificial intelligence workload executing on the system; and
an autoscaler responsive to real-time hardware performance counter metrics from the workload profiler, the autoscaler configured to dynamically vary a quantity of active micro-containers within the at least one physical core to maintain a target performance level.

2. The system of claim 1, further comprising a communication layer configured to provide shared-memory message-passing channels between the plurality of micro-containers.

3. The system of claim 2, wherein the communication layer is implemented using lock-free ring buffers.

4. The system of claim 1, wherein each micro-container is assigned a dedicated slice of L2 cache memory.

5. The system of claim 1, wherein the hardware performance metrics include instructions-per-cycle (IPC), and wherein the autoscaler is configured to increase the quantity of active micro-containers when the IPC falls below a predetermined threshold.

6. The system of claim 1, wherein the workload profiler is configured to classify a General Matrix Multiply (GEMM) saturation level of the artificial intelligence workload.

7. The system of claim 1, wherein the autoscaler is further configured to power-gate idle micro-containers in response to thermal metrics.

8. A computer-implemented method of executing an artificial-intelligence workload on a processor having a plurality of physical CPU cores, the method comprising:
instantiating, via an orchestration engine, a plurality of micro-containers by logically partitioning a physical CPU core into a plurality of isolated execution sandboxes;
binding tasks from the artificial-intelligence workload to the plurality of micro-containers;
collecting, via a workload profiler, real-time hardware counter metrics associated with the execution of the bound tasks; and
dynamically autoscaling, via an autoscaler responsive to the collected metrics, a quantity of active micro-containers to optimize workload performance.

9. The method of claim 8, further comprising facilitating inter-micro-container communication via shared-memory ring buffers.

10. The method of claim 8, wherein collecting metrics includes sampling instructions-per-cycle (IPC).

11. The method of claim 10, wherein autoscaling includes increasing the quantity of active micro-containers when the sampled IPC falls below a target threshold.

12. The method of claim 8, wherein profiling the workload includes classifying the workload based on its tensor operation patterns.

13. The method of claim 8, further comprising migrating a task from a first micro-container to a second micro-container in response to a thermal throttling event.

14. A non-transitory computer-readable medium storing instructions which, when executed by a processor, cause the processor to perform the method of claim 8.
